(19) United States
(12) Patent Application Publication
(10) Pub. No.: US 2022/0072617 A1
(43) Pub. Date: Mar. 10, 2022

(54) MANUFACTURING DEVICE

(71) Applicants: SAFRAN AIRCRAFT ENGINES, Paris (FR); SAFRAN, Paris (FR)

(72) Inventors: Sébastien Yohann POUZET, Moissy-Cramayel (FR); Pierre ANTONY, Moissy-Cramayel (FR); Damien COURAPIED, Moissy-Cramayel (FR)

(73) Assignees: SAFRAN AIRCRAFT ENGINES, Paris (FR); SAFRAN, Paris (FR)

(21) Appl. No.: 17/415,212

(22) PCT Filed: Dec. 18, 2019
(86) PCT No.: PCT/FR2019/053164

§ 371 Date: Jun. 17, 2021

(30) Foreign Application Priority Data
Dec. 18, 2018 (FR) 1873240

(51) Int. Cl. B22F 10/22; B33Y 10/00; B33Y 30/00; B22F 12/43; B22F 12/90; B33Y 50/00; B23K 26/0622; B23K 26/03; B23K 26/00; B23K 26/342

(52) U.S. Cl. CPC B22F 10/22; B33Y 10/00; B33Y 30/00; B22F 12/43; B22F 12/90; B33Y 50/00; B23K 26/127; B23K 26/034; B23K 26/032; B23K 26/0093; B23K 26/342; B22F 2301/205; B23K 26/0622

(57) ABSTRACT

The invention relates to a device (1) for manufacturing a part (100) made of metallic material, comprising a depositing member (2) made of said metallic material. The device (1) further comprises an impacting member (4) of the material being deposited by emitting an energy beam (5), so as to locally modify its crystalline structure.

### FIELD OF THE INVENTION AND STATE OF THE ART

The invention relates to the field of manufacturing titanium-based alloy parts. The invention applies more particularly, but not exclusively, to the manufacture of a titanium alloy casing comprising, for example, a hooking portion or a sealing portion extending radially inwardly of said casing.

In order to manufacture a titanium-based alloy casing in one piece, it is generally necessary to form the main annular portion and the secondary portions from the same material. Moreover, it is often difficult to cast large titanium-based alloy casings. There is therefore a need for a device and a manufacturing process that make it possible to produce large parts easily and inexpensively. A known solution consists in supplying metal with an additive manufacturing device by direct metal deposition (DMD). Additive manufacturing makes it possible to produce large parts with complex shapes in one piece. However, this method leads to the generation of columnar microstructures, which are not acceptable for mechanically stressed parts. In addition, this method generates residual stresses in the part that can lead to part failure during manufacturing.

Consequently, it would be desirable to have a solution allowing a part with a better crystal structure to be manufactured by material deposition.

### GENERAL PRESENTATION OF THE INVENTION

In this context, the objective of the present invention is to provide a manufacturing device for depositing material to manufacture parts with improved crystalline properties that reduce residual stresses in the manufactured part.

According to a first aspect, the invention relates to a device for manufacturing a part made of metallic material, comprising a member for depositing said metallic material. The device also comprises a member for impacting the material being deposited by emitting an energy beam, so as to locally modify its crystal structure.

### DESCRIPTION OF THE FIGURES

Other features and advantages of the invention will emerge from the following description, which is purely illustrative and non-limiting, and should be read in conjunction with the appended figures in which:

FIG. 1 is a diagram of a device according to the invention,

FIG. 2 is a diagram of the focusing of an impact laser beam on the deposited material.

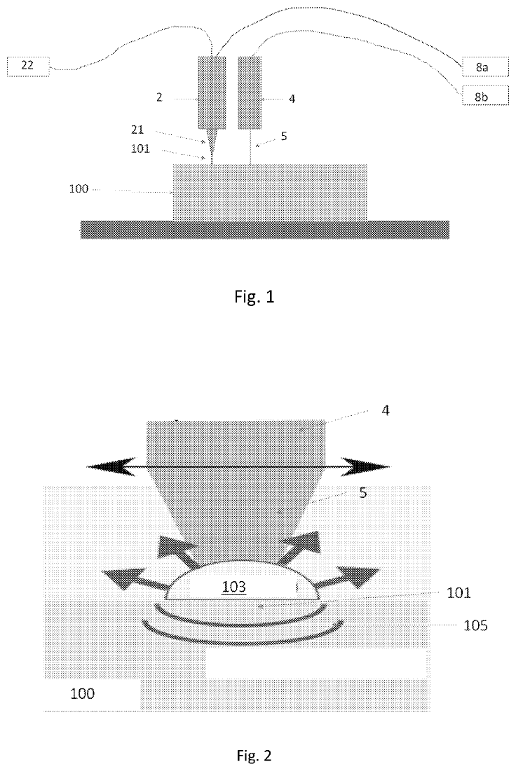

### DETAILED DESCRIPTION OF THE INVENTION

Manufacturing Device

According to a first aspect, the invention relates to a device 1 for manufacturing a titanium-based alloy part 100.

The manufacturing device 1 essentially comprises a member 2 for depositing a bead 101 of molten metal (to form the part 100) and at least one impact member 4 emitting an energy beam 5.

Deposition Member

Typically, the deposition member 2 is a known deposition member of the DMD type.

Thus, the deposition member 2 may comprise a deposition head 21 emitting an energy beam (for example, an electron beam or a laser) that meets a metal wire or a stream of metal powder from a material supply 22. The beam from the deposition head 21 is focused to melt the metal. The deposition head 21 deposits the molten metal in the form of beads 101. Preferentially, the deposited metal can be a titanium-based alloy, typically a TA6V type alloy.

According to the embodiment shown here, the deposition head 21 is powered by a first electrical source 8a.

Impact Member

The impact member 4 is a particularly advantageous provision of the invention. According to the embodiment presented here, the impact member 4 is a laser. In general, and as will be explained below, the impact member 4 is adapted to focus the energy beam 5 on the newly deposited bead 101 of material, in order to modify the crystal structure of the metal part 100, in particular into a substantially equiaxed structure. As will be explained below, the impact member allows the material to be locally strain-hardened and a mechanical wave to be propagated in the part. As will be detailed below, said mechanical wave allows the material to relax (i.e., to modify its crystal structure), in order to eliminate any residual stresses.

Preferably, the impact member 4 is a pulsed nanosecond laser, adapted to emit pulses over a duration of 5 to 150 nanoseconds. In a particularly preferred manner, the laser emits pulses with a duration of 10 to 100 nanoseconds. Furthermore, the laser beam preferentially has an energy comprised between 5 and 15 joules, and particularly preferentially between 9 and 11 joules. As will be described below, the impact member 4 is positioned so as to be able to focus the energy beam 5 on a bead 101 previously deposited by the deposition member 2.

Moreover, the laser has a frequency comprised between 5 Hz and 15 Hz, and preferentially between 9 Hz and 11 Hz.

According to the embodiment presented here, the impact member 4 is powered by a second electrical source 8b.

It is specified that the device 1 could be powered by a single electrical source. The use of two distinct sources responds best to the laser power calls of the impact member 4.

Servo Control

The deposition member 2 and the impact member 4 are slaved and synchronized. Indeed, as will be described below, it is necessary for the impact member 4 to focus the energy beam 5 on the recently deposited bead 101 of material and at a defined temperature (which will be specified later). Consequently, the deposition member 2 and the impact member 4 can be attached to the same robot arm. Alternatively, the deposition member 2 and the impact member 4 can each be attached to a separate robot arm. This arrangement offers greater freedom in path generation. In this case, the two arms must be slaved and driven in correspondence.

In addition, the device 1 can include a temperature control system comprising a camera coupled to a pyrometer. Thus, it is possible to permanently control the temperature of the device 1 and, more particularly, the temperature of the beads 101.

In the example presented here, in the case of a deposition of a TA6V type titanium-based alloy, it is advantageous to block the growth of the grains before the phase change of the material around 800° C. Consequently, the impact must be performed just after solidification and before the microstructure is formed. Particularly advantageously, the use of a laser as an impact member 4 makes it possible to carry out the impacts during cooling from 1600° C. to 800° C., which maximizes the effect on the microstructure. It should be recalled that the impact puts a constraint in one direction which prevents the growth of grains in this same direction. An equiaxed, thus isotropic, microstructure, which has better mechanical properties, is thus obtained.

In order to synchronize the laser impact with the displacement of the deposition member 2, it is necessary to control the distance between the liquid bath generated by the deposition member 2 and the impact zone. This distance must be small enough to keep the temperature high (for example above 800° C.) but large enough not to disturb the deposition (for example below 1600° C.). By estimating the cooling gradient of the deposited bead and the feed speed of the deposition member 2, this distance must be between 5 mm and 50 mm. The numerous parameters and variabilities specific to the different deposition processes do not allow this distance simply to be imposed. In order to control this distance, as previously mentioned, a temperature control is carried out.

To this end, a pyrometer measures the temperature in the center of the impact zone in order to generate a TTL signal that controls the triggering of the laser impact. A waiting time between two laser pulses is imposed to take into account the diameter of the impact zone.

This waiting time (toff) is calculated in order to take into account the rate (percentage) of overlapping (Tau), the diameter of the desired impact (D) and the speed of advance (V) of the deposition nozzle given by the numerical control according to the formula toff=(D*(1−Tau/100))/A. The pyrometer can be substituted by a thermal camera with temperature monitoring by image processing. In the same way, a signal is generated according to the pixel value level in the center of the impact zone to trigger the shot.

Closed Enclosure

Advantageously, the device 1 may have a closed enclosure (not shown) for manufacturing the part 100 in a controlled atmosphere. An inductor can be used to control the temperature of the part. The inductor is preferentially connected to the temperature control devices, in order to guarantee a fine temperature control.

Manufacturing Process and Operation of the Device

According to a second aspect, the invention relates to a process for manufacturing a titanium alloy part 100 using the device 1.

Essentially, the process comprises depositing beads 101 of metal to form a metal part 100 and focusing the energy beam 5 on at least one of the beads 101 to modify the crystal structure of the metal part 100 to an equiaxed structure.

More precisely, the deposition member 2 deposits the beads 101, according to a determined path, to manufacture a part 100. The principle is the well-known one of additive manufacturing. Thus, the part 100 is manufactured layer-by-layer by successively depositing beads 101 of molten metal. At the same time, the impact member 4 focuses the beam 5 on the beads 101 to modify the crystal microstructure and thus modify the crystal structure of the whole part 100.

As diagrammed in FIG. 2, when a laser beam is focused on a bead 101 deposited on the part 100 under construction, a plasma 103 is formed during the impact of the laser beam on the drop 101. The energy released by the formation of the plasma generates a mechanical wave 105 which will both break the metal microstructures of the bead 101 (to obtain in fine an equiaxed microstructure) and locally strain-harden the material. In addition, the mechanical wave 105, while propagating in the part 100 under construction, will relax the material and thus eliminate any residual stresses. In other words, the material is locally constrained (strain-hardening) but globally relaxed. For a better understanding, the phenomenon at issue can be compared to forging. Thus, locally at the point of impact of the forging hammer the material is strain-hardened, but globally, the impact wave of the impact relaxes the internal structures of the part. It is specified that this is only a comparison to explain the process according to the invention. The local stress of each bead 101 is relaxed during the deposition of top layers of beads 101 and the propagation of mechanical waves related to the laser impacts on the beads 101 of the top layers.

Thus, particularly advantageously, the focusing of an energy beam 5 successively to the deposition of the bead 101 makes it possible to change the microstructure of the part 100 during its manufacture and thus to avoid the formation of long columnar grains and the generation of residual stresses.

It is specified that the optimal result is achieved when the energy beam 5 is focused on a bead 101 having a temperature comprised between 30° C. and 200° C., and preferentially between 50° C. and 150° C.

Part Obtained by the Process

According to a third aspect, the invention relates to a part 100 directly obtained by the process according to the invention. As detailed above, the process according to the invention makes it possible to manufacture a large part that may have a complex geometry.

The part 100 may, for example, be a turbomachine casing.

1. A device (1) for manufacturing a part (100) made of metallic material, comprising a member (2) for depositing said metallic material, characterized in that it also comprises an impact member (4) for impacting the material being deposited by emitting an energy beam (5), so as to locally modify its crystal structure.

2. The device (1) as claimed in claim 1, wherein the deposition member (2) is configured to deposit beads (101) of molten metal.

3. The device (1) as claimed in claim 2, wherein the deposition member (2) is configured to deposit beads (10) of molten titanium-based alloy.

4. The device (1) as claimed in claim 2, wherein the impact member (4) is configured to focus the energy beam (5) on at least one of the beads (101).

5. The device (1) as claimed in claim 1, wherein the impact member (4) is adapted to locally modify the crystal structure into a substantially equiaxed structure.

6. The manufacturing device (1) as claimed in claim 1, wherein said impact member (4) is a laser, preferentially a pulsed laser having a pulse duration comprised between 5 nanoseconds and 150 nanoseconds.

7. The device (1) as claimed in claim 1, comprising a closed enclosure confining the deposition member (2) and the impact member (4).

8. The device (1) as claimed in claim 7, comprising an inductor for regulating a temperature in the closed enclosure, a camera coupled to a pyrometer for viewing the part and measuring the temperature before the energy beam (5) is emitted by the impact member (4).

9. A process for manufacturing a titanium-based alloy part (100), using a device (1) as claimed in claim 1, the process comprising focusing an energy beam (5) on material being deposited, in order to locally modify the crystal structure of the material.

10. The process as claimed in claim 9, comprising locally strain-hardening the material by the energy beam (5).

11. The process as claimed in claims 2, the process comprising focusing an energy beam (5) on material being deposited, in order to locally modify the crystal structure of the material, wherein, upon contact with said bead (101), the laser generates a plasma (103), the generation of the plasma (103) releasing a mechanical wave (105) strain-hardening the bead (101) and relaxing at least a portion of the part (100).

12. A part (100) directly obtained by a process as claimed in claim 8.
